(19) United States
(12) Patent Application Publication
(10) Pub. No.: US 2025/0024075 A1
(43) Pub. Date: Jan. 16, 2025

(54) METHOD FOR DECODING IMMERSIVE VIDEO AND METHOD FOR ENCODING IMMERSIVE VIDEO

(71) Applicant: Electronics and Telecommunications Research Institute, Daejeon (KR)

(72) Inventors: Hong Chang SHIN, Daejeon (KR); Gwang Soon LEE, Daejeon (KR)

(73) Assignee: Electronics and Telecommunications Research Institute, Daejeon (KR)

(21) Appl. No.: 18/771,269

(22) Filed: Jul. 12, 2024

(30) Foreign Application Priority Data
Jul. 14, 2023 (KR) 10-2023-0091821
Oct. 10, 2023 (KR) 10-2023-0134649
Jul. 10, 2024 (KR) 10-2024-0091382

(51) Int. Cl. H04N 19/597; H04N 19/182; H04N 19/186

(52) U.S. Cl. CPC H04N 19/597; H04N 19/182; H04N 19/186

(57) ABSTRACT

An image encoding method according to the present disclosure may include generating an atlas based on at least one two-dimensional or three-dimensional image; and encoding the atlas and metadata for the atlas. In this case, the metadata may include information about a patch packed in the atlas, and the patch information may include information about a three-dimensional point projected on a two-dimensional patch.

This application claims the benefit of Korean Patent Application No. 10-2023-0091821, filed Jul. 14, 2023, and Korean Patent Application No. 10-2023-0134649, filed Oct. 10, 2023, and Korean Patent Application No. 10-2024-0091382, filed Jul. 10, 2024, which are hereby incorporated by reference in their entireties into this application.

### TECHNICAL FIELD

The present disclosure relates to a method for encoding/decoding an immersive video which supports motion parallax for a rotation and translation motion.

### DESCRIPTION OF THE RELATED ART

A virtual reality service is evolving in a direction of providing a service in which a sense of immersion and realism are maximized by generating an omnidirectional image in a form of an actual image or CG (Computer Graphics) and playing it on HMD, a smartphone, etc. Currently, it is known that 6 Degrees of Freedom (DoF) should be supported to play a natural and immersive omnidirectional image through HMD. For a 6 DoF image, an image which is free in six directions including (1) left and right rotation, (2) top and bottom rotation, (3) left and right movement, (4) top and bottom movement, etc. should be provided through a HMD screen. But, most of the omnidirectional images based on an actual image support only rotary motion. Accordingly, a study on a field such as acquisition, reproduction technology, etc. of a 6 DoF omnidirectional image is actively under way.

### DISCLOSURE

### Technical Problem

The present disclosure is to provide a method of encoding/decoding a spherical harmonic function.

The present disclosure is to provide a method of determining a position where a spherical harmonic function will be encoded/decoded.

The technical objects to be achieved by the present disclosure are not limited to the above-described technical objects, and other technical objects which are not described herein will be clearly understood by those skilled in the pertinent art from the following description.

### Technical Solution

An image encoding method according to the present disclosure may include generating an atlas based on at least one two-dimensional or three-dimensional image; and encoding the atlas and metadata for the atlas. In this case, the metadata may include information about a patch packed in the atlas, and the patch information may include information about a three-dimensional point projected on a two-dimensional patch.

In an image encoding method according to the present disclosure, information about the three-dimensional point may include at least one of position information, size information, occupancy information or color information by direction on a three-dimensional space of the three-dimensional point.

In an image encoding method according to the present disclosure, a position of the three-dimensional point may be determined based on a multi-layer structure.

In an image encoding method according to the present disclosure, the position information may include information identifying a layer in which the three-dimensional point is included and offset information showing an interval between layers in the multi-layer structure.

In an image encoding method according to the present disclosure, size information of the three-dimensional point may be determined as a radius of a spherical shaped point.

In an image encoding method according to the present disclosure, at least one of the occupancy information of the color information by direction of the three-dimensional point may be calculated based on a view with the smallest loss cost based on a difference value between original information and information reconstructed by all rays incident from a plurality of views.

In an image encoding method according to the present disclosure, the color information by direction may include coefficient information of a spherical harmonic function.

The patch information may further include a flag indicating whether the patch includes a non-Lambert region.

In an image encoding method according to the present disclosure, the patch information may further include a flag indicating whether there are three-dimensional points that are redundantly projected on the same position.

An image decoding method according to the present disclosure may include decoding an atlas and metadata for the atlas; and generating a viewport image by using the atlas and the metadata. In this case, the metadata may include information about a patch packed in the atlas, and the patch information may include information about a three-dimensional point projected on a two-dimensional patch.

In an image decoding method according to the present disclosure, information about the three-dimensional point may include at least one of position information, occupancy information or color information by direction on a three-dimensional space of the three-dimensional point.

In an image decoding method according to the present disclosure, the position information may include information identifying a layer in which the three-dimensional point is included and offset information showing an interval between layers under a multi-layer structure.

In an image decoding method according to the present disclosure, size information of the three-dimensional point may be determined as a radius of a spherical shaped point.

In an image decoding method according to the present disclosure, the occupancy information may show a probability that the three-dimensional point is a non-Lambert surface.

In an image decoding method according to the present disclosure, the color information by direction may include coefficient information of a spherical harmonic function.

In an image decoding method according to the present disclosure, the patch information may further include a flag indicating whether the patch includes a non-Lambert region.

In an image decoding method according to the present disclosure, when a pixel to be reconstructed in the viewport image is included in a non-Lambert region, a value of the pixel may be obtained based on transparency information or color information by direction of the three-dimensional point.

In an image decoding method according to the present disclosure, the patch information may further include a flag indicating whether there are three-dimensional points that are redundantly projected on the same position.

The technical objects to be achieved by the present disclosure are not limited to the above-described technical objects, and other technical objects which are not described herein will be clearly understood by those skilled in the pertinent art from the following description.

### Technical Effects

According to the present disclosure, based on a spherical harmonic function, there is an effect of improving image quality by expressing a texture considering reflected light.

According to the present disclosure, there is an effect of reducing the amount of data to be encoded/decoded by selecting a position where information on a spherical harmonic function is encoded/decoded.

Effects achievable by the present disclosure are not limited to the above-described effects, and other effects which are not described herein may be clearly understood by those skilled in the pertinent art from the following description.

### BRIEF DESCRIPTION OF DRAWINGS

FIG. 1 is a block diagram of an immersive video processing device according to an embodiment of the present disclosure.

FIG. 2 is a block diagram of an immersive video output device according to an embodiment of the present disclosure.

FIG. 3 is a flow chart of an immersive video processing method.

FIG. 4 is a flow chart of an atlas encoding process.

FIG. 5 is a flow chart of an immersive video output method.

FIG. 6 represents a plurality of images captured by using cameras with a different view.

FIG. 7 represents a method of removing redundant data between a plurality of view images.

FIG. 8 shows an example in which an object in a three-dimensional space is captured through a plurality of cameras at a different position.

FIG. 9 illustrates a reflection characteristic of an object surface.

FIG. 10 shows a unit grid.

FIG. 11 represents an incidence aspect of rays for reference points.

FIG. 12 shows a case in which a distribution map of information expressed by a sphere is different according to a degree and order of a spherical harmonic function.

FIG. 13 shows an example in which points are arranged in a multi-layer format.

FIGS. 14 to 16 show an example of processing a non-Lambert surface region of a target scene.

FIG. 17 illustrates a projection position of each point in a multi-depth layer configured based on a depth of an object surface shown at a basic view.

FIGS. 18 and 19 are a flowchart of an encoding/decoding method of a non-Lambert region according to an embodiment of the present disclosure.

FIG. 20 shows an example of generating an atlas image by using a semi-basic view image.

### DESCRIPTION OF THE PREFERRED EMBODIMENTS

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

An immersive video, when a user's viewing position is changed, refers to a video that a viewport image may be also dynamically changed. In order to implement an immersive video, a plurality of input images is required. Each of a plurality of input images may be referred to as a source image or a view image. A different view index may be assigned to each view image.

An immersive video may be classified into 3 DoF (Degree of Freedom), 3 DoF+, Windowed-6 DoF or 6 DoF type, etc. A 3 DoF-based immersive video may be implemented by using only a texture image. On the other hand, in order to render an immersive video including depth information such as 3 DoF+ or 6 DoF, etc., a depth image (or, a depth map) as well as a texture image is also required.

It is assumed that the embodiments described below are for immersive video processing including depth information such as 3 DoF+ and/or 6 DoF, etc. In addition, it is assumed that a view image is configured with a texture image and a depth image.

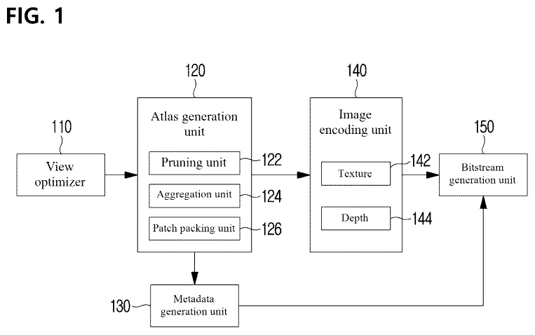

FIG. 1 is a block diagram of an immersive video processing device according to an embodiment of the present disclosure.

In reference to FIG. 1, an immersive video processing device according to the present disclosure may include a view optimizer 110, an atlas generation unit 120, a metadata generation unit 130, an image encoding unit 140, and a bitstream generation unit 150.

An immersive video processing device receives a plurality of pairs of images, intrinsic camera parameters and extrinsic camera parameters as input data to encode an immersive video. Here, a plurality of pairs of images includes a texture image (Attribute component) and a depth image (Geometry component). Each pair may have a different view. Accordingly, a pair of input images may be referred to as a view image. Each of the view images may be divided by an index. In this case, an index assigned to each view image may be referred to as a view or a view index.

Intrinsic camera parameters includes a focal distance, a position of a principal point, etc. and extrinsic camera parameters include translations, rotations, etc. of a camera. Intrinsic camera parameters and extrinsic camera parameters may be treated as a camera parameter or a view parameter.

A view optimizer 110 partitions view images into a plurality of groups. As view images are partitioned into a plurality of groups, independent encoding processing per each group may be performed. In an example, view images captured by N spatially consecutive cameras may be classified into one group. Thereby, view images that depth information is relatively coherent may be put in one group and accordingly, rendering quality may be improved.

In addition, by removing the dependence of information between groups, a spatial random access service which performs rendering by selectively bringing only information in a region that a user is watching may be made available.

Whether view images will be partitioned into a plurality of groups may be optional.

In addition, a view optimizer 110 may classify view images into a basic image and an additional image. A basic image represents an image which is not pruned as a view image with the highest pruning priority and an additional image represents a view image with a pruning priority lower than a basic image.

A view optimizer 110 may determine at least one of the view images as a basic image. A view image which is not selected as a basic image may be classified as an additional image.

A view optimizer 110 may determine a basic image by considering the view position of a view image. In an example, a view image whose view position is the center among a plurality of view images may be selected as a basic image.

Alternatively, a view optimizer 110 may select a basic image based on camera parameters. Specifically, a view optimizer 110 may select a basic image based on at least one of a camera index, a priority between cameras, the position of a camera, or whether it is a camera in a region of interest.

In an example, at least one of a view image with the smallest camera index, a view image with the largest camera index, a view image with the same camera index as a predefined value, a view image captured by a camera with the highest priority, a view image captured by a camera with the lowest priority, a view image captured by a camera at a predefined position (e.g., a central position) or a view image captured by a camera in a region of interest may be determined as a basic image.

Alternatively, a view optimizer 110 may determine a basic image based on the quality of view images. In an example, a view image with the highest quality among view images may be determined as a basic image.

Alternatively, a view optimizer 110 may determine a basic image by considering an overlapping data rate of other view images after inspecting a degree of data redundancy between view images. In an example, a view image with the highest overlapping data rate with other view images or a view image with the lowest overlapping data rate with other view images may be determined as a basic image.

A plurality of view images may be also configured as a basic image.

An Atlas generation unit 120 performs pruning and generates a pruning mask. And, it extracts a patch by using a pruning mask and generates an atlas by combining a basic image and/or an extracted patch. When view images are partitioned into a plurality of groups, the process may be performed independently per each group.

A generated atlas may be composed of a texture atlas and a depth atlas. A texture atlas represents a basic texture image and/or an image that texture patches are combined and a depth atlas represents a basic depth image and/or an image that depth patches are combined.

An atlas generation unit 120 may include a pruning unit 122, an aggregation unit 124, and a patch packing unit 126.

A pruning unit 122 performs pruning for an additional image based on a pruning priority. Specifically, pruning for an additional image may be performed by using a reference image with a higher pruning priority than an additional image.

A reference image includes a basic image. In addition, according to the pruning priority of an additional image, a reference image may further include other additional image.

Whether an additional image may be used as a reference image may be selectively determined. In an example, when an additional image is configured not to be used as a reference image, only a basic image may be configured as a reference image.

On the other hand, when an additional image is configured to be used as a reference image, a basic image and other additional image with a higher pruning priority than an additional image may be configured as a reference image.

Through a pruning process, redundant data between an additional image and a reference image may be removed. Specifically, through a warping process based on a depth image, data overlapped with a reference image may be removed in an additional image. In an example, when a depth value between an additional image and a reference image is compared and that difference is equal to or less than a threshold value, it may be determined that a corresponding pixel is redundant data.

As a result of pruning, a pruning mask including information on whether each pixel in an additional image is valid or invalid may be generated. A pruning mask may be a binary image which represents whether each pixel in an additional image is valid or invalid. In an example, in a pruning mask, a pixel determined as overlapping data with a reference image may have a value of 0 and a pixel determined as non-overlapping data with a reference image may have a value of 1.

While a non-overlapping region may have a non-square shape, a patch is limited to a square shape. Accordingly, a patch may include an invalid region as well as a valid region. Here, a valid region refers to a region composed of non-overlapping pixels between an additional image and a reference image. In other words, a valid region represents a region that includes data which is included in an additional image, but is not included in a reference image. An invalid region refers to a region composed of overlapping pixels between an additional image and a reference image. A pixel/data included by a valid region may be referred to as a valid pixel/valid data and a pixel/data included by an invalid region may be referred to as an invalid pixel/invalid data.

An aggregation unit 124 combines a pruning mask generated in a frame unit in an intra-period unit.

In addition, an aggregation unit 124 may extract a patch from a combined pruning mask image through a clustering process. Specifically, a square region including valid data in a combined pruning mask image may be extracted as a patch. Regardless of the shape of a valid region, a patch is extracted in a square shape, so a patch extracted from a square valid region may include invalid data as well as valid data.

In this case, an aggregation unit 124 may repartition a L-shaped or C-shaped patch which reduces encoding efficiency. Here, a L-shaped patch represents that the distribution of a valid region is L-shaped and a C-shaped patch represents that the distribution of a valid region is C-shaped.

When the distribution of a valid region is L-shaped or C-shaped, a region occupied by an invalid region in a patch is relatively large. Accordingly, a L-shaped or C-shaped patch may be partitioned into a plurality of patches to improve encoding efficiency.

For an unpruned view image, a whole view image may be treated as one patch. Specifically, a whole 2D image which develops an unpruned view image in a predetermined projection format may be treated as one patch. A projection format may include at least one of an Equirectangular Projection Format (ERP), a Cube-map, or a Perspective Projection Format.

Here, an unpruned view image refers to a basic image with the highest pruning priority. Alternatively, an additional image that there is no overlapping data with a reference image and a basic image may be defined as an unpruned view image. Alternatively, regardless of whether there is overlapping data with a reference image, an additional image arbitrarily excluded from a pruning target may be also defined as an unpruned view image. In other words, even an additional image that there is data overlapping with a reference image may be defined as an unpruned view image.

A packing unit 126 packs a patch in a rectangle image. In patch packing, deformation such as size transform, rotation, or flip, etc. of a patch may be accompanied. An image that patches are packed may be defined as an atlas.

Specifically, packing unit 126 may generate a texture atlas by packing a basic texture image and/or texture patches and may generate a depth atlas by packing a basic depth image and/or depth patches.

For a basic image, a whole basic image may be treated as one patch. In other words, a basic image may be packed in an atlas as it is. When a whole image is treated as one patch, a corresponding patch may be referred to as a complete image (complete view) or a complete patch.

The number of atlases generated by an atlas generation unit 120 may be determined based on at least one of the arrangement structures of a camera rig, the accuracy of a depth map, or the number of view images.

A metadata generation unit 130 generates metadata for image synthesis. Metadata may include at least one of camera-related data, pruning-related data, atlas-related data, or patch-related data.

Pruning-related data includes information for determining a pruning priority between view images. In an example, at least one of the flag representing whether a view image is a root node or a flag representing whether a view image is a leaf node may be encoded. A root node represents a view image with the highest pruning priority (i.e., a basic image) and a leaf node represents a view image with the lowest pruning priority.

When a view image is not a root node, a parent node index may be additionally encoded. A parent node index may represent an image index of a view image, a parent node.

Alternatively, when a view image is not a leaf node, a child node index may be additionally encoded. A child node index may represent an image index of a view image, a child node.

Atlas-related data may include at least one of size information of an atlas, number information of an atlas, priority information between atlases or a flag representing whether an atlas includes a complete image. A size of an atlas may include at least one of size information of a texture atlas and size information of a depth atlas. In this case, a flag representing whether a size of a depth atlas is the same as that of a texture atlas may be additionally encoded. When a size of a depth atlas is different from that of a texture atlas, reduction ratio information of a depth atlas (e.g., scaling-related information) may be additionally encoded. Atlas-related information may be included in a “View parameters list” item in a bitstream.

In an example, geometry_scale_enabled_flag, a syntax representing whether it is allowed to reduce a depth atlas, may be encoded/decoded. When a value of a syntax geometry_scale_enabled_flag is 0, it represents that it is not allowed to reduce a depth atlas. In this case, a depth atlas has the same size as a texture atlas.

When a value of a syntax geometry_scale_enabled_flag is 1, it represents that it is allowed to reduce a depth atlas. In this case, information for determining a reduction ratio of a depth atlas may be additionally encoded/decoded. In an example, geometry_scaling_factor_x, a syntax representing a horizontal directional reduction ratio of a depth atlas, and geometry_scaling_factor_y, a syntax representing a vertical directional reduction ratio of a depth atlas, may be additionally encoded/decoded.

An immersive video output device may restore a reduced depth atlas to its original size after decoding information on a reduction ratio of a depth atlas.

Patch-related data includes information for specifying a position and/or a size of a patch in an atlas image, a view image to which a patch belongs and a position and/or a size of a patch in a view image. In an example, at least one of position information representing a position of a patch in an atlas image or size information representing a size of a patch in an atlas image may be encoded. In addition, a source index for identifying a view image from which a patch is derived may be encoded. A source index represents an index of a view image, an original source of a patch. In addition, position information representing a position corresponding to a patch in a view image or position information representing a size corresponding to a patch in a view image may be encoded. Patch-related information may be included in an “Atlas data” item in a bitstream.

An image encoding unit 140 encodes an atlas. When view images are classified into a plurality of groups, an atlas may be generated per group. Accordingly, image encoding may be performed independently per group.

An image encoding unit 140 may include a texture image encoding unit 142 encoding a texture atlas and a depth image encoding unit 144 encoding a depth atlas.

A bitstream generation unit 150 generates a bitstream based on encoded image data and metadata. A generated bitstream may be transmitted to an immersive video output device.

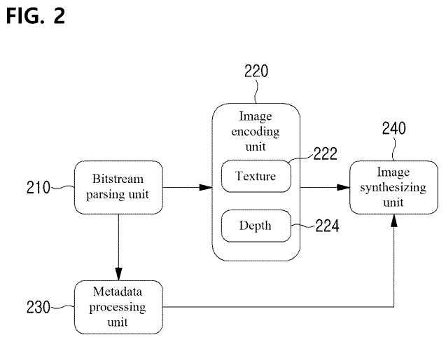

FIG. 2 is a block diagram of an immersive video output device according to an embodiment of the present disclosure.

In reference to FIG. 2, an immersive video output device according to the present disclosure may include a bitstream parsing unit 210, an image decoding unit 220, a metadata processing unit 230 and an image synthesizing unit 240.

A bitstream parsing unit 210 parses image data and metadata from a bitstream. Image data may include data of an encoded atlas. When a spatial random access service is supported, only a partial bitstream including a watching position of a user may be received.

An image decoding unit 220 decodes parsed image data. An image decoding unit 220 may include a texture image decoding unit 222 for decoding a texture atlas and a depth image decoding unit 224 for decoding a depth atlas.

A metadata processing unit 230 unformats parsed metadata.

Unformatted metadata may be used to synthesize a specific view image. In an example, when motion information of a user is input to an immersive video output device, a metadata processing unit 230 may determine an atlas necessary for image synthesis and patches necessary for image synthesis and/or a position/a size of the patches in an atlas and others to reproduce a viewport image according to a user's motion.

An image synthesizing unit 240 may dynamically synthesize a viewport image according to a user's motion. Specifically, an image synthesizing unit 240 may extract patches required to synthesize a viewport image from an atlas by using information determined in a metadata processing unit 230 according to a user's motion. Specifically, a viewport image may be generated by extracting patches extracted from an atlas including information of a view image required to synthesize a viewport image and the view image in the atlas and synthesizing extracted patches.

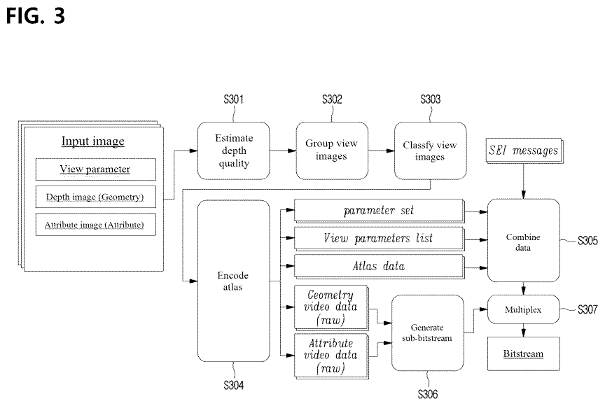

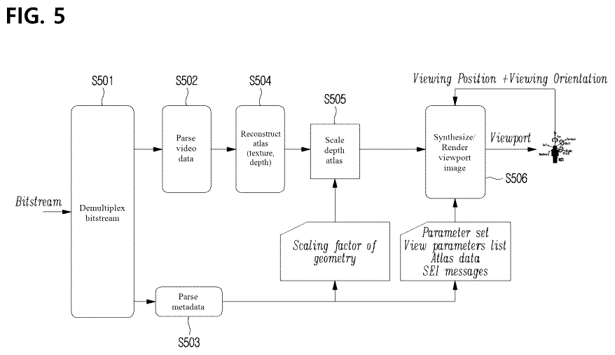

FIGS. 3 and 5 show a flow chart of an immersive video processing method and an immersive video output method, respectively.

In the following flow charts, what is italicized or underlined represents input or output data for performing each step. In addition, in the following flow charts, an arrow represents processing order of each step. In this case, steps without an arrow indicate that temporal order between corresponding steps is not determined or that corresponding steps may be processed in parallel. In addition, it is also possible to process or output an immersive video in order different from that shown in the following flow charts.

An immersive video processing device may receive at least one of a plurality of input images, a camera internal variable and a camera external variable and evaluate depth map quality through input data S301. Here, an input image may be configured with a pair of a texture image (Attribute component) and a depth image (Geometry component).

An immersive video processing device may classify input images into a plurality of groups based on positional proximity of a plurality of cameras S302. By classifying input images into a plurality of groups, pruning and encoding may be performed independently between adjacent cameras whose depth value is relatively coherent. In addition, through the process, a spatial random access service that rendering is performed by using only information of a region a user is watching may be enabled.

But, the above-described S301 and S302 are just an optional procedure and this process is not necessarily performed.

When input images are classified into a plurality of groups, procedures which will be described below may be performed independently per group.

An immersive video processing device may determine a pruning priority of view images S303. Specifically, view images may be classified into a basic image and an additional image and a pruning priority between additional images may be configured.

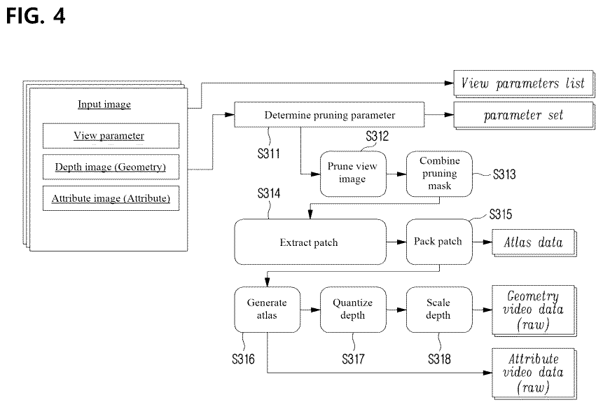

Subsequently, based on a pruning priority, an atlas may be generated and a generated atlas may be encoded S304. A process of encoding atlases is shown in detail in FIG. 4.

Specifically, a pruning parameter (e.g., a pruning priority, etc.) may be determined S311 and based on a determined pruning parameter, pruning may be performed for view images S312. As a result of pruning, a basic image with a highest priority is maintained as it is originally. On the other hand, through pruning for an additional image, overlapping data between an additional image and a reference image is removed. Through a warping process based on a depth image, overlapping data between an additional image and a reference image may be removed.

As a result of pruning, a pruning mask may be generated. If a pruning mask is generated, a pruning mask is combined in a unit of an intra-period S313. And, a patch may be extracted from a texture image and a depth image by using a combined pruning mask S314. Specifically, a combined pruning mask may be masked to texture images and depth images to extract a patch.

In this case, for an non-pruned view image (e.g., a basic image), a whole view image may be treated as one patch.

Subsequently, extracted patches may be packed S315 and an atlas may be generated S316. Specifically, a texture atlas and a depth atlas may be generated.

In addition, an immersive video processing device may determine a threshold value for determining whether a pixel is valid or invalid based on a depth atlas S317. In an example, a pixel that a value in an atlas is smaller than a threshold value may correspond to an invalid pixel and a pixel that a value is equal to or greater than a threshold value may correspond to a valid pixel. A threshold value may be determined in a unit of an image or may be determined in a unit of a patch.

For reducing the amount of data, a size of a depth atlas may be reduced by a specific ratio S318. When a size of a depth atlas is reduced, information on a reduction ratio of a depth atlas (e.g., a scaling factor) may be encoded. In an immersive video output device, a reduced depth atlas may be restored to its original size through a scaling factor and a size of a texture atlas.

Metadata generated in an atlas encoding process (e.g., a parameter set, a view parameter list or atlas data, etc.) and SEI (Supplemental Enhancement Information) are combined S305. In addition, a sub bitstream may be generated by encoding a texture atlas and a depth atlas respectively S306. And, a single bitstream may be generated by multiplexing encoded metadata and an encoded atlas S307.

An immersive video output device demultiplexes a bitstream received from an immersive video processing device S501. As a result, video data, i.e., atlas data and metadata may be extracted respectively S502 and S503.

An immersive video output device may restore an atlas based on parsed video data S504. In this case, when a depth atlas is reduced at a specific ratio, a depth atlas may be scaled to its original size by acquiring related information from metadata S505.

When a user's motion occurs, based on metadata, an atlas required to synthesize a viewport image according to a user's motion may be determined and patches included in the atlas may be extracted. A viewport image may be generated and rendered S506. In this case, in order to synthesize viewpoint image with the patches, size/position information of each patch and a camera parameter, etc. may be used.

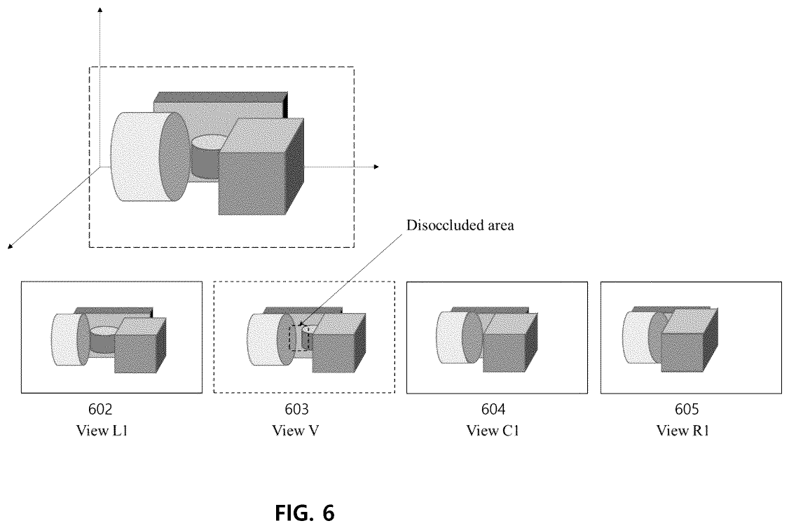

FIG. 6 represents a plurality of images captured by using cameras with a different view.

When ViewC1 604 is referred to as a central view, ViewL1 602 and ViewR1 605 represent a left view image of a central view and a right view image of a central view, respectively.

When a virtual view image ViewV 603 between a central view ViewC1 and a left view image ViewL1 is generated, there may be a region which is hidden in a central view image ViewC1, but is visible in a left view image ViewL1. Accordingly, image synthesis for a virtual view image ViewV may be performed by referring to a left view image ViewL1 as well as a central view image ViewC1.

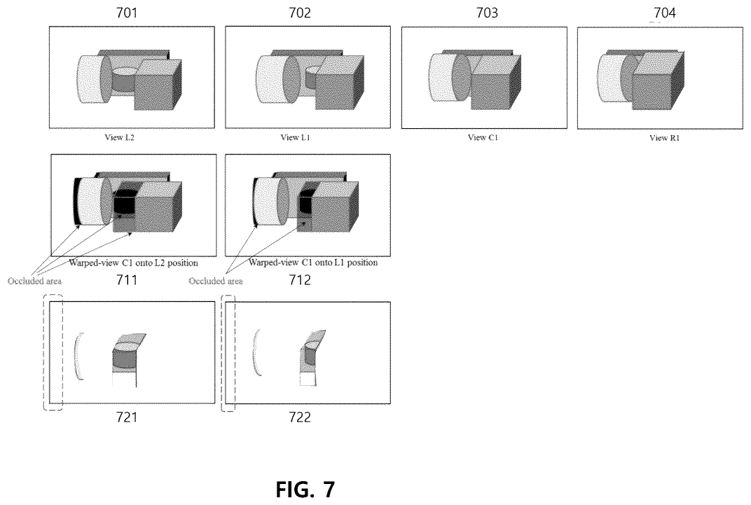

FIG. 7 represents a method of removing redundant data between a plurality of view images.

A basic view among a plurality of view images is selected and for non-basic view images, redundant data with a basic view is removed. In an example, when a central view ViewC1 is referred to as a basic view, remaining views excluding ViewC1 become an additional view used as a reference image in synthesis. All pixels of a basic view image may be mapped to a position of an additional view image by using a three-dimensional geometric relationship and depth information (depth map) of each view image. In this case, mapping may be performed through a 3D view warping process.

In an example, as in an example shown in FIG. 7, a basic view image ViewC1 may be mapped to a position of a first left view image ViewL1 702 to generate a first warped image 712 and a basic view image ViewC1 may be mapped to a position of a second left view image ViewL2 701 to generate a second warped image 711.

In this case, a region which is invisible due to observation parallax in a basic view image ViewC1 is processed as a hole region without data in an warped image. A region where data (i.e., a color) exists except for a hole region may be a region which is also visible in a basic view image ViewC1.

A pruning process for removing an overlapped pixel may be performed through a procedure for confirming whether an overlapped pixel between a basic view and an additional view may be determined as redundancy. In an example, as in an example shown in FIG. 7, a first residual image 722 may be generated through pruning between a first warped image and a first left view image and a second residual image 721 may be generated through pruning between a second warped image and a second left view image. By reducing image data through a pruning process, compression efficiency may be improved in encoding an image.

Meanwhile, a determination on an overlapped pixel may be based on whether at least one of a color value difference and/or a depth value difference for pixels at the same position is smaller than a threshold. In an example, when at least one of a color value difference and a depth value difference is smaller than a threshold, both pixels may be determined to be overlapped pixels.

In this case, a case may occur in which they are determined to be an overlapped pixel although they are not an overlapped pixel due to a problem such as a color or a depth value noise in an image, an error in a camera calibration value or an error in a decision equation. In addition, a case may also occur in which a color value is different depending on the position of a camera used to capture the pixel due to a characteristic of a reflective surface of various materials in a scene and a source of light even between pixels at the same position. Accordingly, although a pruning process is very accurate, information expressing a scene may be lost, which may cause image quality deterioration when rendering a target view image in a decoder.

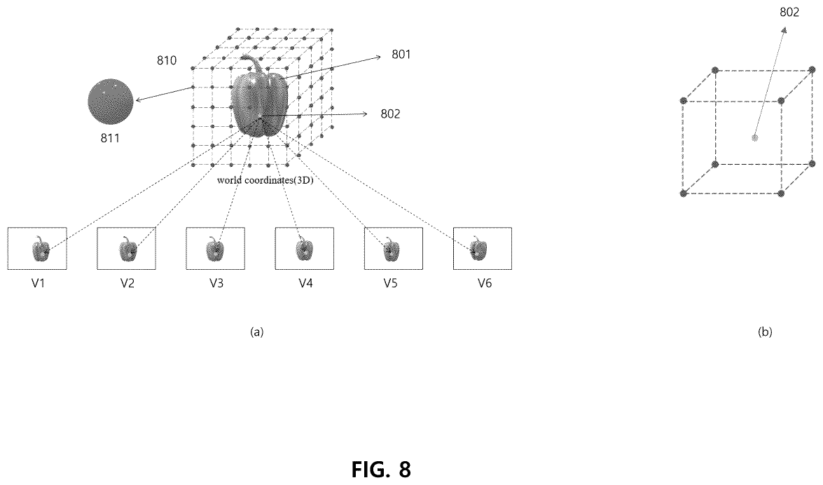

FIG. 8 shows an example in which an object in a three-dimensional space is captured through a plurality of cameras at a different position.

In FIG. 8(a), it is assumed that each image is projected into a two-dimensional image.

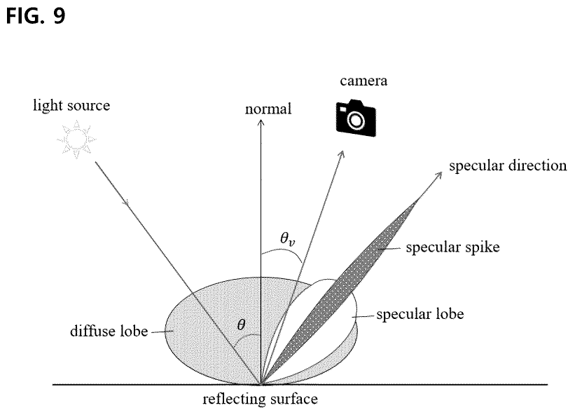

In FIG. 8(a), V1 to V6 represent view images captured by cameras having a different capturing angle (pose). As in a shown example, according to a capturing angle (pose) and a position of a camera acquiring an object, even the same point in a three-dimensional space may have a different aspect of being projected into a two-dimensional image. In an example, when an any one point 802 on an object is projected on each of view images V1 to V6, according to a camera capturing angle (pose), a pixel value corresponding to the any one point 802 in a projected two-dimensional image may be not the same, but different between corrective images. It is because, as in FIG. 9 to be described later, that color value may vary depending on the angle of viewing the same point due to a reflection characteristic of an object surface.

FIG. 9 illustrates a reflection characteristic of an object surface.

As in an example shown in FIG. generally according to a reflection characteristic of an object surface, a main component of reflection may be classified into at least one of a diffuse lobe, a specular lobe or a specular spike component.

As a diffuse lobe is a Lambertian surface, it refers to a region having the same brightness regardless of an observer's viewing angle.

A specular lobe is a part which causes reflection multiple times (approximately, 2-3 times) on a surface by a defect on an object surface.

A specular spike component, like perfect specular reflection, is a region where information on a reflective surface acquired by 100% reflection from a specific surface may be lost.

In general, an object surface has a mixed reflective surface characteristic that one or more of listed reflective components are complexly mixed.

Similarly, object 801 shown in FIG. 8(a) may also have different brightness per view due to a characteristic of a reflective surface and a light source.

However, when pixels corresponding to any one point 802 on an object in view images are determined to be an overlapped pixel, through a pruning process, a pixel in a basic view image is maintained and a pixel in an additional view image is removed. In other words, although pixels corresponding to any one point 802 on an object in view images have different brightness, if a difference in depth values (or color values) is less than or equal to a threshold value, they are determined as an overlapped pixel.

A pruning process removes data redundancy to improve data compression efficiency, but as in the example, determines pixels with different brightness as an overlapped pixel to cause a loss in information quantity, resulting in image quality deterioration in rendering in a decoder.

In particular, a color value on a surface such as a mirror that an incident light source is totally reflected or a transparent object that an incident light source is refracted, not a diffused reflection surface, may be determined as an overlapping pixel and removed in a pruning process although a color value is totally different according to an angle.

In order to reconstruct a color value of a real mixed reflective surface which looks different according to an observer's viewing position and angle, it is required to have information for all viewing angles as well as a specific angle or a method of modeling a reflective characteristic of a mixed reflective surface may be considered. Hereinafter, a method of modeling a reflective characteristic of a mixed reflective surface is described in detail.

A three-dimensional region of interest to which an object in a target scene belongs may be expressed in a three-dimensional grid structure. In an example, in an example shown in FIG. 8(a), it was illustrated that a space including an object 801 is expressed in a three-dimensional grid structure expressed by a world coordinate system. Here, a three-dimensional grid structure refers to a cluster in which three-dimensional points at an even interval are arranged and in an example, a code 811 approximates one of three-dimensional points in a sphere shape. As in an example shown in FIG. 8(b), any point 802 represents a three-dimensional point corresponding to any intermediate position in a three-dimensional grid structure.

A three-dimensional grid structure including an object of FIG. 8 may be understood as being configured with an unit cellforming a cubic grid.

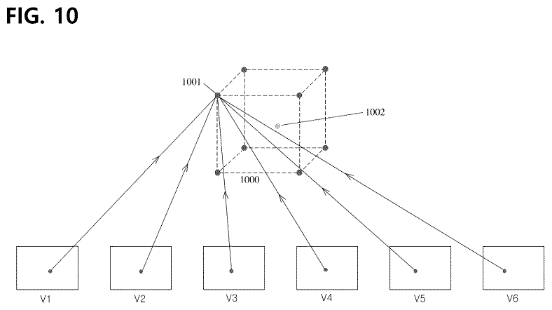

FIG. 10 shows a unit grid.

In FIG. 10, it was shown that from a pixel of each of view images (V1˜V6), for a point 1001 configuring a unit grid, unprojection is performed in a form of a ray. As in a shown example, unprojection may be performed in a form of a ray from a pixel of a view image to a point 1001 configuring a unit grid by using camera calibration information corresponding to a view image. In this case, if a color value of a ray projected on a point 1001 from each view image is referred to, a color value of a point 1001 for any view may be estimated.

Furthermore, if a color value of 8 points configuring a grid 1000 may be estimated by referring to pixels in view images (V1˜V6), a value of at least one of a color value, a brightness value or opacity for any point 1002 in a grid may be estimated. In other words, 8 points configuring a grid may be used as reference points or a method such as tri-linear interpolation, an average or weighted operation, etc. of reference points may be used to estimate information on a target point 1002 in a grid.

Here, if a size (scaling) of each point configuring a grid is the same, information about a target point may be estimated through a simple method such as three-dimensional linear interpolation, etc. On the other hand, if a size of points configuring a grid is different, when a point 1001 is projected on a target view, a size component may be modeled as an additional parameter to ensure that an occupied region (or space) when the color intensity information of a ray for a point projected on a target view image (viewport) is rasterized may be variable. Through this, a target scene expression parameter may be optimized.

In other words, based on size information, occupancy at a position projected on a target view image and rasterized may be set as a weight value, and information about a target point 1001 may be estimated through a weighted operation of points configuring a voxel.

Meanwhile, size information may basically show the radius of a circle or a sphere. In this case, for a point existing in a three-dimensional space, a radius for each of a x-axis, a y-axis, and a z-axis may be set individually. When a radius of at least one of a x-axis, a y-axis, and a z-axis is different from another axis, it shows that the shape of a point is an ellipsoid. By applying the method to a three-dimensional grid cluster, for any view, a target object may be reconstructed. On the other hand, as an interval of points configuring a three-dimensional grid cluster surrounding a target object gets closer, a target object may be reconstructed at a higher resolution.

In order to reconstruct a target object by the method, for all reference points configuring a three-dimensional grid cluster for a target object, a color value according to an incidence angle (i.e., a capturing angle) of a ray unprojected from each camera should be known.

Meanwhile, the number of lines passing through a reference point in the form of a ray may be variable depending on at least one of the number of cameras (i.e., view images), an image resolution, or a camera geometry.

As the angles of the rays incident from cameras (i.e., view images) to a reference point become more diverse, a color value for each view direction or incidence angle of a target point may be accurately reconstructed. In other words, as reflected light information representing information when a light source reflected from a target point is projected on each camera (i.e., each view image) increases (i.e., reflected light information of a light source is acquired at a variety of angles), a target point may be realistically reconstructed at a variety of views and directions.

As in an example shown in FIG. 8(a), when it is assumed that a reference point has one sphere form 811 with a radius of r, a color value at a moment when a ray is reflected while passing a corresponding reference point may be stored as reflected light information. Meanwhile, the reflected light information may be stored per incidence angle (or direction) of a ray.

When any view image is synthesized, reflected light information may be utilized to reconstruct a suitable color according to an angle of observing a corresponding reference point.

Meanwhile, the number of rays which are unprojected from a view image and incident on a reference point may be different per reference point.

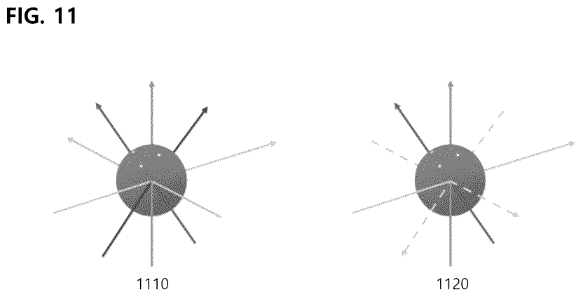

FIG. 11 represents an incidence aspect of rays for reference points.

In an example shown in FIG. 11, it was illustrated that 5 rays are incident on a first reference point 1110 and 3 rays are incident on a second reference point 1120. Since the number of rays incident on a first reference point 1110 is greater than the number of rays incident on a second reference point 1120, it may be understood that incident light source information for a first reference point 1110 is more diverse than incident light source information for a second reference point 1120. Accordingly, when any view image is synthesized, a first reference point 1110 may be reconstructed with a color with a high sense of reality at more various angles than a second reference point 1120.

However, the maximum number of rays incident on each of a first reference point 1110 and a second reference point 1120 is limited to the number of view images (i.e., cameras) and accordingly, incident light source information may be acquired only for an incidence angle corresponding to each of view images. In other words, since incident light source information is not acquired for all omnidirectional angles, information for arbitrary directions (angle) that a ray is not incident may be estimated through approximation using neighboring values.

In other words, information such as a color of a ray reflected from a reference point may be configured as a neighboring value and a color value in a space or in a direction that a ray is not incident may be estimated by using at least one neighboring value.

Meanwhile, when a reference point is assumed to have a spherical form, through Laplace's equation in spherical coordinates, distribution of reflected light intensity on a spherical surface may be approximated based on a neighboring value. In an example, distribution of reflected light intensity may be approximated by using spherical harmonic functions.

Equation 1 below represents spherical harmonic functions.

$${Y}_{l , m} ( θ , ϕ ) = \{ \begin{matrix}{c}_{l . m} {P}_{l}^{\vert m \vert} ( cos θ ) sin ( \vert m \vert ϕ ) & - l \leq m \leq 0 \\ \frac{{c}_{l , m}}{\sqrt{2}} {P}_{l}^{0} ( cos θ ) & m = 0 \\ {c}_{l , m} , {P}_{l}^{m} ( cos θ ) ( m ϕ ) & 0 \leq m \leq l\end{matrix} \qquad [ Equation l ]$$

In Equation 1, Y_{l,m} represents a spherical harmonic function. θ is an angle with a z-axis in a positive direction in a spherical coordinate system and ϕ is an angle with a x-axis in a positive direction having a z-axis as an axis. Since the function is consecutive, l is a non-negative integer and m is an integer satisfying −l≤m≤l.

In Equation 1, c_{l,m} may be derived according to the following Equation 2.

$${c}_{l , m} = \sqrt{\frac{2 l + 1}{2 π} \frac{( l + \vert m \vert ! )}{( l + \vert m \vert ! )}} \qquad [ Equation 2 ]$$

In addition, in Equation 1, Pₗ^{m} represents a Legendre Polynomials.

When a spherical harmonic function approximating spherical distribution of a reflected light component at a target point is referred to as \tilde{f}, \tilde{f} may be represented as a weighted sum of Y_{l,m}, basis functions of spherical harmonics at the reference points, as in the following Equation 3.

$$\tilde{f} ( θ , ϕ ) = {Σ}_{l , m} {c}_{l m} {Y}_{l m} ( θ , ϕ ) \qquad [ Equation 3 ]$$

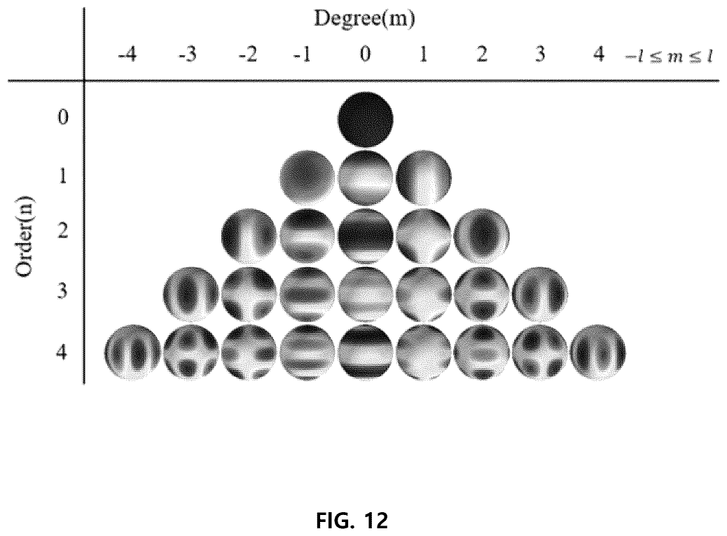

FIG. 12 shows a case in which a distribution map of information expressed by a sphere is different according to the degree and order of spherical harmonic functions.

In an example shown in FIG. 12, when it is assumed that a degree of spherical harmonic functions is 2, the spherical harmonic functions at a target point may be approximated with 9 basis functions, a sum of information which may be expressed in degree of 2 or less (1 basis function when the degree is 0, 3 basis functions when the degree is 1, and 5 basis functions when the degree is 2). When a degree of a spherical harmonic function is 3, a spherical harmonic function at a target point may be approximated with 16 basis functions and when a degree is 4, a spherical harmonic function at a target point may be approximated with 25 basis functions. Here, the number of basis functions may have the same concept as the number of coefficients configuring a spherical harmonic function.

As the degree of spherical harmonic functions increases, it becomes possible to approximate the reflected light component information corresponding to local regions on the spherical coordinate system separately from other regions. In other words, with higher degree of spherical harmonic functions, the high-frequency components of reflected light expressed in the local region on a spherical coordinate system are included.

In reference to intensity of a ray incident on a spherical target point, the intensity per direction of reflected light component information which may be expressed by a corresponding spherical body may be approximated. Specifically, when a degree of a spherical harmonic function is 2, the spherical harmonic function for a target point may be approximated by calculating a weight function for a total of 9 basis functions.

In this case, when Equation 3 includes information on a coefficient corresponding to a weight of a basis function Y_{l,m}, it may be used to approximate the target point and accordingly, reflected light information in any direction may be reconstructed. In order to approximate the intensity of primary colors, R, G, and B, the weight of a basis function should be calculated by referring to intensity of each channel individually.

By applying the above-described spherical harmonic function to a video encoder/decoder structure, a pixel value for a target point at any view may be reconstructed. Specifically, an encoder may encode a coefficient of basis functions in a form of metadata to transmit it to a decoder and a decoder may use a received coefficient to reconstruct reflected light information in any direction for a target point. In this case, the minimum size of data for encoding a coefficient is calculated by multiplying the number of points configuring a three-dimensional grid cluster by the number of basis functions (the number of coefficients) of a spherical harmonic function as in the following Equation 4.

$$Minimum Metadata size = Number of Elements \times \qquad [ Equation 4 ]$$

$$Number of Coefficients \times Date size per Coefficient$$

In addition, size information for determining the size of a point configuring a three-dimensional grid cluster may also be encoded/decoded together. As an example, the size information may include information showing the radius of a circle or a sphere. Alternatively, the size information may include information showing the radius for each of a x-axis, a y-axis, and a z-axis.

Meanwhile, information showing a shape of a point may also be additionally encoded/decoded. As an example, when shape information indicates that a point is circular or spherical, information showing a radius may be encoded and signaled for only one of a x-axis, a y-axis, and a z-axis. On the other hand, when shape information indicates that a point is elliptical, information showing a radius may be encoded and signaled for each of a x-axis, a y-axis, and a z-axis.

Meanwhile, along with spherical harmonic functions, a position of a point must also be encoded/decoded together. If a position of each point is directly encoded/decoded, a large amount of bits are required to encode/decode a position of points. In order to reduce the amount of data required to encode a position of a point, points may be arranged in a multi-layer format.

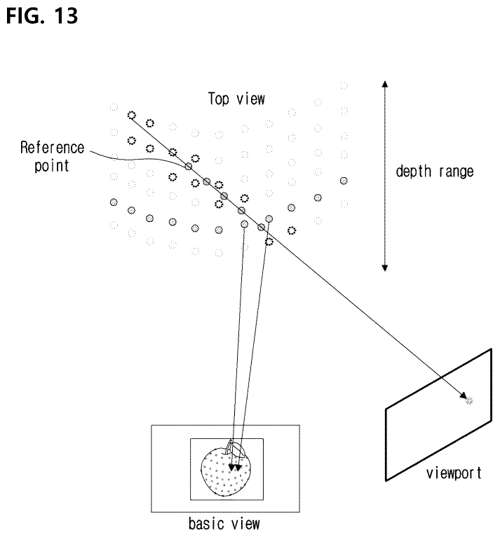

FIG. 13 shows an example in which points are arranged in a multi-layer format.

As in an example shown in FIG. 13, points may be arranged at a regular interval based on the depth information of a target scene.

In an example shown in FIG. 13, points are assigned at a regular interval based on a coordinate on an object surface (hereinafter, referred to as a surface coordinate). Meanwhile, in an example shown in FIG. 13, a surface coordinate may be designated based on a basic view and its depth information.

As in an example shown in FIG. 13, points may be arranged based on a surface coordinate to define the position of each point as a relative distance from a surface coordinate. Accordingly, the amount of data required to encode/decode a position of points may be reduced compared to directly encoding/decoding a coordinate of each point. As an example, when an index of a layer to which a point belongs is i, a corresponding point may be understood as being separated from a layer with an index of 0 that includes a surface coordinate by i times an offset. In addition, the position of a point in a layer may be derived based on an index of a matrix to which a point in a layer belongs. As an example, when an index of a column to which a point belongs is j, a x-axis coordinate of a corresponding point may be set as j times an offset, and when an index of a row to which a point belongs is k, a y-axis coordinate of a corresponding point may be set as k times an offset.

Meanwhile, a coordinate of three-dimensional points may be defined based on the depth information of a basic view. Alternatively, a coordinate of three-dimensional points may be defined based on a valid depth range of a target scene.

As in an example shown in FIG. 13, when a ray is unprojected in a target scene direction on a three-dimensional space, if a spherical harmonic function for positions through which a ray passes is defined, opacity for all points and coefficients of a spherical harmonic function may be derived based thereon. Points at a position through which a ray passes may be referred to as a reference point.

Equation 5 shows a formula for deriving opacity and a color value for N reference points positioned on a ray, in a process in which a ray is unprojected in a target scene direction, from each pixel within a plurality of reference view images.

$${C}_{R} ( r ) = {\sum }_{i = 1}^{N} {T}_{i} ( 1 - exp ( - {σ}_{i} {δ}_{i} ) ) {c}_{i} \qquad [ Equation 5 ]$$

In Equation 5 above, C_{R}(r) represents a reconstructed color value of an input ray. N represents the number of reference points on a corresponding ray, and i represents an index of each reference point. σ represents opacity, δ represents spacing (i.e., an offset) between reference points, and c represents a color value. Tᵢ represents a transmittance of a reference point whose index is i. Tᵢ, a transmittance of a reference point, may be derived as in Equation 6 below.

$${T}_{i} = exp ( - {Σ}_{j = 1}^{i - 1} {σ}_{j} {δ}_{j} ) \qquad [ Equation 6 ]$$

Reference points on a ray processed by Equation 5 may be processed sequentially in the order of distances from a camera. In this case, as shown in Equation 6, an i-th reference point may be derived by referring to opacity σⱼ accumulated and interval δⱼ accumulated to a previous reference point (i.e., a i-1-th reference point).

In Equation 5, cᵢ represents a color value of an i-th reference point, and a corresponding value may vary depending on the direction of a ray. Accordingly, cᵢ, a color value of a reference point, may be derived based on a spherical harmonic function.

C_{R}(r), a color of a ray reconstructed by Equation 5, may be determined as a value that minimizes a difference with a value of an original view image (i.e., C(r)). As an example, C_{R}(r), an optimal reconstructed color value of a ray, may be obtained through an optimization process according to Equations 7 and 8 below.

$${L}_{r e c o n} = \frac{1}{\vert ℛ \vert} {\sum }_{r ∈ R} ‖ C ( r ) - \hat{C} ( r ) {‖}_{2}^{2} \qquad [ Equation 7 ]$$

$$L = {L}_{r e c o n} + λ α \qquad [ Equation 8 ]$$

As in an example of Equation 7, for each ray belonging to set R, a difference between a reconstructed color value C_{R}(r) and a color value C(r) of an original image corresponding thereto may be derived, and a difference value for all rays belonging to set R may be averaged to derive a loss cost L_{recon}. Afterwards, a weight λ may be applied to an additional loss cost α calculated by an additional constraint, and a loss cost L_{recon} and a weighted additional loss cost λα may be combined to derive the total loss cost L. A reconstructed color value C_{R}(r) for all rays may be derived based on a view when the total loss cost L derived in Equation 8 is low among a plurality of views.

When a reconstructed color value C_{R}(r) is derived, the coefficients of spherical harmonic functions and the opacity value at the positions of points configuring a target scene may be derived.

Meanwhile, opacity may also be referred to as occupancy. A value of opacity or occupancy may represent a probability that incident light will be reflected or transmitted to a particle on a three-dimensional space at each point. As an example, a high probability that incident light will be reflected to a particle on a three-dimensional space may mean that a corresponding point is highly likely to be positioned on the surface of an object or a background. Considering a characteristic as above, a value of opacity or occupancy may be utilized as a probability value for deriving a distance (i.e., a depth value) between a point and a camera by using the geometric information of a target scene (e.g., camera calibration information of a target scene).

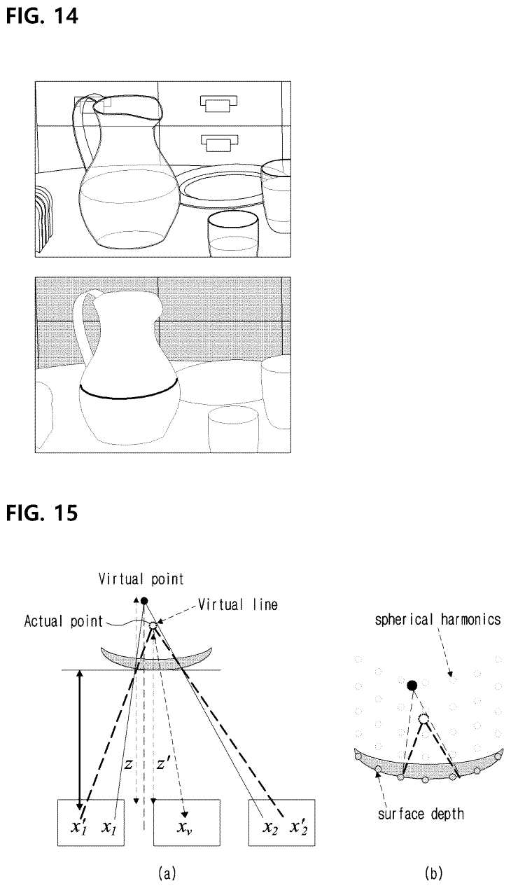

FIGS. 14 to 16 show an example of processing a non-Lambert surface region of a target scene.

FIG. 14 illustrates a phenomenon in which incident light is refracted on a transparent water bottle surface.

When using a traditional depth image-based image synthesis technique (Depth Image Based Rendering), a problem occurs in which the synthesis/rendering quality of a non-Lambert surface deteriorates.

Specifically, as in an example shown in FIG. 15(a), if there is no refraction between an arbitrary three-dimensional point and a camera, a three-dimensional point must be projected on the x1 and x2 positions of a camera. However, in a situation where refraction occurs between an arbitrary three-dimensional point and a camera (e.g., as in an example shown in FIG. 14, when there is transparent glass), an arbitrary three-dimensional position is projected on x′1 and x′2 positions, not the x1 and x2 positions of a camera.

Depth information is defined by assuming that a position and a depth value on a three-dimensional space have linearity, but as in an example shown in FIG. 15(a), when refraction occurs between a three-dimensional point and a camera, linearity between a position and a depth value on a three-dimensional space is not maintained. Accordingly, when using a depth image-based image synthesis technique, an ambiguity phenomenon occurs in which a geometric relationship between corresponding points between reference views may not be accurately specified. Generally, when synthesizing a target view image, pixels at the same position (i.e., corresponding pixels) are blended from reference views to reproduce a pixel value, but due to an ambiguity phenomenon, a visual artefact occurs in a process of blending pixels at the same position.

In addition, in an example shown in FIG. 14, an ambiguity phenomenon may be minimized only when a depth value for the inside of the water bottle is measured based on a virtual direction (i.e., a direction considering refraction) from the surface of the water bottle to the inside of the water bottle, but in general, a depth value is calculated based on a straight line direction from the outside of the water bottle to the inside of the water bottle without considering refraction. Accordingly, there is a problem that a depth value of regions refracted by the surface of the water bottle may not be accurately calculated.

In order to solve a problem as above, as in an example shown in FIG. 15(b), for a non-Lambert region where refraction or unspecific reflection occurs, three-dimensional points may be arranged in a direction deeper than a surface. As three-dimensional points are arranged in a layer form, an additional depth layer may be generated.

And then, as in an example shown in FIG. 15(b), based on Equations 5 to 8 described above, an optimal reconstructed color value for all rays unprojected from the multi-reference viewpoint pixels may be calculated, and it may be used to derive the color information by direction (i.e., the coefficient information of a spherical harmonic function) and occupancy information of three-dimensional points at a position through which a ray passes.

Afterwards, the color information by direction and occupancy information of each point may be used to derive a color value and occupancy at an arbitrary three-dimensional position. As an example, as in an example shown in FIG. 16, a color value and occupancy at a target point may be calculated by using the tri-linear interpolation of a plurality of points. In this case, a plurality of points may configure a voxel (i.e., a polyhedron) including a target point, as in an example shown in FIG. 16.

Meanwhile, the above-described embodiments may be equally applied not only to a refractive region illustrated in FIGS. 14 to 16, but also to a specular reflection region (e.g., a mirror), a specular lobe region or a specular spike region.

As described, when a non-Lambert region in an image is designated through custom or a detection algorithm, an image encoder may configure multiple depth layers based on a designated non-Lambert region. In other words, points may be arranged in a form of multiple layers by using a non-Lambert region as a surface, and according to embodiments through Equations 5 to 8, color information by direction (i.e., the coefficient information of a spherical harmonic function) and occupancy at each point may be calculated.

Afterwards, color information by direction and occupancy information may be patched for each point and packed into at least one region, and may be encoded and signaled together with an attribute (e.g., a texture) component.

Meanwhile, occupancy information about each point may be directly encoded and transmitted, or an additional depth layer image generated based on occupancy information about each point may be encoded and transmitted. In other words, as in an example shown in FIG. 15(b), a plurality of depth layers may be generated based on a non-Lambert surface, and the coefficient information of a spherical harmonic function may be encoded/decoded for points configuring each depth layer.

In addition, at least one of a position/a size of a target region, a position/a size of a patch or an identifier of a view image necessary to render a target region (e.g., a viewport region) may be included in metadata and encoded.

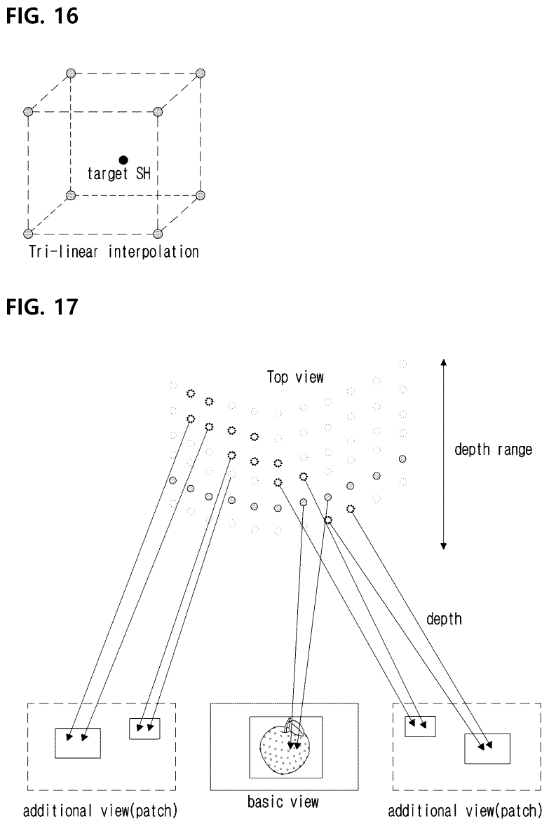

FIG. 17 illustrates a projection position of each point in a multi-depth layer configured based on the depth of an object surface shown at a basic view.

Specifically, FIG. 17 illustrates an example in which three-dimensional points are projected on a two-dimensional image at a basic view and an additional view.

As in an example shown in FIG. 17, when three-dimensional points are projected on a two-dimensional image, there may be a case in which a valid three-dimensional point is occluded according to the arrangement of objects. Accordingly, when projecting three-dimensional points in a two-dimensional way, if a plurality of points are projected on an overlapping position and some of them are occluded, information on some of a plurality of points projected on an overlapping position may be missing. In order to solve this problem, whether each three-dimensional point is occluded may be inspected and reflected to generate a patch. In other words, at least one of information indicating whether a patch includes an occluded point or whether a plurality of three-dimensional points exists at a specific position within a patch may be encoded as metadata and signaled.

In a process of projecting a three-dimensional point on a two-dimensional image and packing a patch extracted from a two-dimensional image, it is necessary to encode/decode the coordinate information of an original three-dimensional point. In this case, a coordinate value of each three-dimensional point may be set as an absolute coordinate value of each three-dimensional point. Alternatively, a coordinate of a three-dimensional point may be calculated based on a depth from a reference surface or a distance between reference coordinates arbitrarily set in a three-dimensional way. Alternatively, a valid depth range may be set and three-dimensional points may be arranged at a certain offset interval to determine a coordinate of a three-dimensional point based on an index and an offset of a layer to which a three-dimensional point belongs. When an index and an offset are used, there is an effect of reducing the amount of data to be encoded/decoded.

Meanwhile, the information of a three-dimensional point encoded may include at least one of position information (i.e., a coordinate), occupancy information or color information by direction of a point.

As another example, when packing the information of a three-dimensional point in an image encoder, only occupancy information may be packed, and color information by direction may be excluded from a packing target. Alternatively, instead of packing occupancy information, an additional depth layer image generated based on occupancy information may be encoded/decoded. A depth value in an additional depth layer image may be estimated according to the occupancy of each point.

Meanwhile, color information by direction may include the coefficient information of spherical harmonic functions. As an example, for a three-dimensional point, at least one of arrangement information including a coefficient value and/or the number of coefficients (the number of taps) of the spherical harmonic functions may be encoded/decoded.

In this case, when the order of a spherical harmonic function is 2, 9 floating data is required for each point. For a three-channel (e.g., RGB) image, 27 floating data is required for each point. As there are more points, more data may be required to encode/decode a spherical harmonic function. Considering this, for at least one of the view images for rendering a target image, pruning may not be performed on a region for rendering a target image. In other words, a partial image within a view image for rendering a target image may be fully packed into an atlas as one patch. In this case, for a corresponding patch, as a non-Lambert region, a flag showing whether it must be processed with occupancy information additionally transmitted may be encoded/decoded.

When a patch corresponds to a non-Lambert region, for a corresponding patch, at least one of occupancy information or matching information with an additional depth layer image may be further encoded/decoded as metadata.

Generally, a non-Lambert region may be part of an image, not the entire region. Accordingly, when after detecting a non-Lambert region from an image, the above-described information is packed into an atlas and encoded only for a detected region, or is encoded as metadata, it may contribute to improving a data compression ratio.

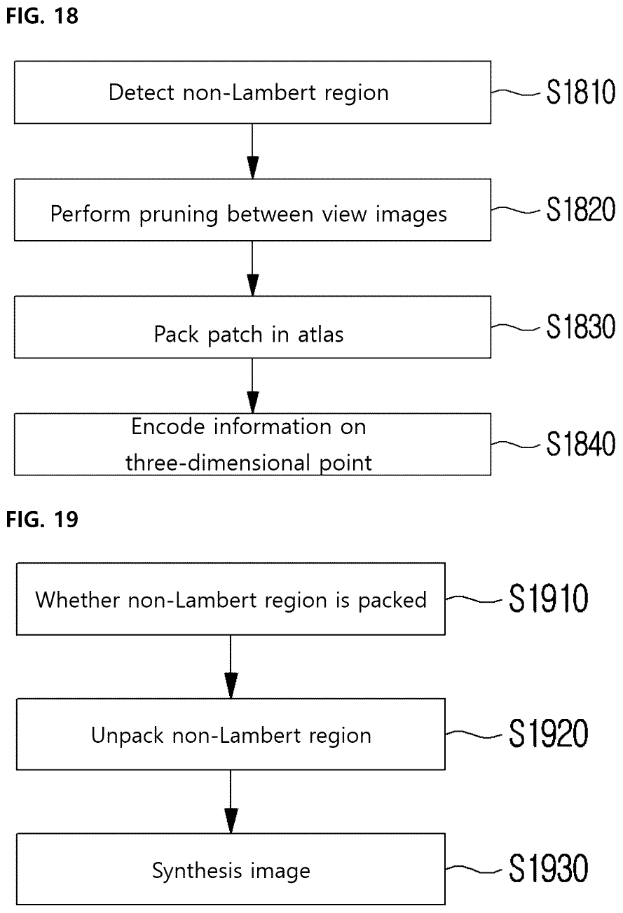

FIGS. 18 and 19 are a flowchart of an encoding/decoding method of a non-Lambert region according to an embodiment of the present disclosure.

Referring to FIG. 18, first, a non-Lambert region may be detected from a view image S1810. A non-Lambert region may be performed before performing pruning in an image encoder. It is to adaptively determine whether to perform pruning on a non-Lambert region.

A non-Lambert region may be automatically detected by a computer vision algorithm. As an example, a non-Lambert region may be detected based on whether a difference between a specific pixel in a target scene and pixels of an original view image on which the specific pixel is projected is equal to or greater than a threshold value. For example, a region where a difference between pixel values is equal to or greater than a threshold value may be set as a non-Lambert region.

Alternatively, a non-Lambert region may be designated by user input. As an example, a mask image where a non-Lambert region is indicated may be input to a non-Lambert region detection step. As a result, a mask image where a non-Lambert region is indicated may be output.

Afterwards, pruning is performed between view images S1820. Meanwhile, pruning may not be performed for a non-Lambert region, or pruning may not be performed only for a non-Lambert region included in a target image.

According to a result of pruning, a patch may be extracted, and an extracted patch may be packed to generate an atlas S1830. Meanwhile, when pruning is not performed for a non-Lambert region, a non-Lambert region may be packed into an atlas as one patch.

For a patch including a non-Lambert region, information on three-dimensional points may be additionally encoded. As an example, at least one of the number of three-dimensional points projected on a corresponding patch, information on each three-dimensional point or information indicating whether an occluded three-dimensional point is included may be encoded. Here, information on a three-dimensional point may include at least one of position information, occupancy information or color value information by direction (e.g., the coefficient information of a spherical harmonic function) of three-dimensional information.

Meanwhile, at least one of information showing whether a non-Lambert region is packed for an atlas, information showing whether a non-Lambert region is included for a specific view or information showing whether a corresponding patch includes a non-Lambert region for a specific patch may be encoded/decoded.

Instead of encoding/decoding the information of three-dimensional points by packing a patch into an atlas, information of three-dimensional points may also be encoded/decoded as additional information (i.e., metadata) for expressing a scene.

In an image decoder, metadata showing whether a non-Lambert region is packed may be referred to S1910, and when a non-Lambert region is packed, a non-Lambert region may be unpacked S1920. In addition, information necessary for synthesizing a non-Lambert region and additional information are loaded into a memory, and then an image is synthesized by using them S1930.

As an example, when a pixel to be reproduced is a pixel in a non-Lambert region, a pixel value may be derived by using the occupancy information and color value information by direction of points.

On the other hand, when a pixel to be reproduced is a pixel belonging to a region that is not a non-Lambert region (hereinafter, referred to as a general region), a pixel value may be derived by using a conventional method, i.e., by blending a plurality of images at the same position.

As another example, a pixel value of a pixel included in a non-Lambert region may be derived by using a first pixel value derived based on the transparency information and color value information by direction of three-dimensional points and a second pixel value derived by blending a plurality of pixels at the same position. As an example, a pixel value of a pixel included in a non-Lambert region may be obtained by an average or a weighted sum operation between a first pixel value and a second pixel value.

In this case, a weight for a weighted sum operation between a first pixel value and a second pixel value may be determined based on the occupancy information of three-dimensional points.

Meanwhile, as described above, view images may be classified into a basic view image and an additional view image, and according to a classification result, pruning may be performed on view images. In packing a patch extracted through pruning into an atlas, one of position transformation, rotation transform or size transform for a patch may be applied, unlike a position or a size in an original view image.

As another example, a semi-basic view image may be additionally defined, and view images may be classified into at least one of a basic view image, a semi-basic view image or an additional view image.

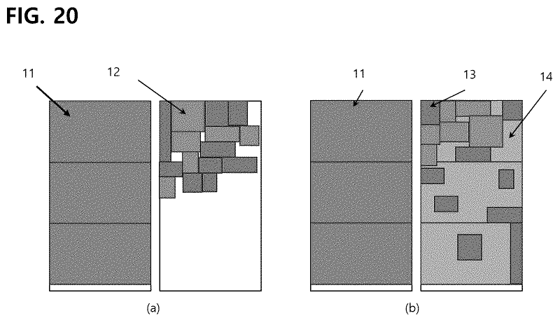

FIG. 20 shows an example of generating an atlas image by using a semi-basic view image.

An example shown in FIG. 20(a) shows an example of generating atlas images when a semi-basic view image is not used, and an example shown in FIG. 20(b) shows an example of generating atlas images when a semi-basic view image is used.

In addition, Reference Numeral 11 represents a patch extracted from a basic view image, and Reference Numeral 12 represents a patch extracted from an additional view image.

Reference Numeral 13 represents a valid region in a semi-basic view image, and Reference Numeral 14 represents an invalid region in a semi-basic view image.

As in an example shown in FIG. 20(a), when a MIV profile consists of two atlas images, generally, a first atlas image may be filled with at least one unpruned basic view image. On the other hand, a second atlas image may be filled with patches extracted from pruned additional view images.

In this case, at least one of additional view images may be set as a semi-basic view image, and a semi-basic view image may be packed into an atlas in a similar manner to a basic view.

As an example, as in an example shown in FIG. 20(b), a pruned semi-basic view image may be packed into an atlas as it is.

Meanwhile, unlike a basic view image, pruning is performed on a semi-basic view image, so a pruned semi-basic view image does not exist as a region where the entire region is valid like a basic view image. In other words, as in an example shown in FIG. 20(b), both a patch 13 corresponding to a valid region in a semi-basic view image and an invalid region 14 in a semi-basic view image are packed into an atlas image.

In this case, a patch 12 extracted from an additional view image may be packed into an invalid region 14 in a semi-basic view image.

Meanwhile, in a method for determining a pruning priority, N images with the highest priority among the additional view images may be set as a semi-basic view image. Here, N may be an integer such as 0, 1, or 2.

Meanwhile, at least one of a flag indicating whether a semi-basic view image exists, information showing the number of semi-basic view images or identification information identifying a semi-basic view image may be encoded and signaled.

Alternatively, on a pruning graph, N view images with a high priority among the additional view images that are a sub-node of a basic view image may be automatically set as a semi-basic view image.

Meanwhile, in the above-described embodiments, it was illustrated that pruning is performed between view images and a patch is extracted from a result of pruning view images to generate an atlas. As another example, after performing pruning for a point cloud, the above-described embodiments may be applied to an atlas generated by a result of performing the pruning.

Here, a point cloud may be composed of vertexes or voxels positioned on a multidimensional space, and a multidimensional space may represent a three-dimensional space or higher.

Meanwhile, pruning for a point cloud may be to remove some vertexes or voxels and reduce the total amount of data in order to improve quality through data compression or noise removal.

Each vertex configuring vertexes or voxels on a pruned point cloud may be projected on a two-dimensional plane, and projected vertexes may be patched, and then packed into a two-dimensional image to generate an atlas.

Alternatively, the entire data that is clustered in an arbitrary shape on a multidimensional space including a two-dimensional space and a three-dimensional space may be partitioned in a certain size or in a certain unit to generate data in a small-cluster unit.

Afterwards, each small-cluster data may be transformed into a two-dimensional or three-dimensional patch data standard through a dimension reduction process. A patch data standard collectively refers to a data structure in a packable container form, and a set of the patches may be defined as an atlas. Meanwhile, the packing information of patch data may be additionally generated as metadata.

A vertex or a voxel configuring a point cloud refers to arbitrary point data positioned on a multidimensional space. Point data may include at least one of position information, size (scaling) information, direction information (orientations), color intensity information according to a direction (an azimuth), or feature data in a matrix or vector form defined through an optimization process.

A name of syntax elements introduced in the above-described embodiments is just temporarily given to describe embodiments according to the present disclosure. Syntax elements may be named differently from what was proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

1. An image encoding method, the method comprising:
generating an atlas from at least one two-dimensional or three-dimensional image; and
encoding the atlas and metadata for the atlas,
wherein the metadata includes information about a patch packed in the atlas,
the patch information includes information about a three-dimensional point projected on a two-dimensional patch.

2. The method of claim 1, wherein:
the information about the three-dimensional point includes at least one of position information, size information, occupancy information or color information by direction on a three-dimensional space of the three-dimensional point.

3. The method of claim 2, wherein:
a position of the three-dimensional point is determined based on a multi-layer structure.

4. The method of claim 3, wherein:
the position information includes information identifying a layer in which the three-dimensional point is included and offset information showing an interval between layers in the multi-layer structure.

5. The method of claim 2, wherein:
size information of the three-dimensional point is determined as a radius of a spherical shaped point.

6. The method of claim 2, wherein:
at least one of the occupancy information or the color information by direction of the three-dimensional point is calculated based on a view with a smallest loss cost based on a difference value between original information and information reconstructed by all rays incident from a plurality of views.

7. The method of claim 2, wherein:
the color information by direction includes coefficient information of a spherical harmonic function.

8. The method of claim 1, wherein:
the patch information further includes a flag indicating whether the patch includes a non-Lambert region.

9. The method of claim 1, wherein:
the patch information further includes a flag indicating whether there are three-dimensional points that are redundantly projected on a same position.

10. An image decoding method, the method comprising:
decoding an atlas and metadata for the atlas; and
generating a viewport image by using the atlas and the metadata,
wherein the metadata includes information about a patch packed in the atlas,
the patch information includes information about a three-dimensional point projected on a two-dimensional patch.

11. The method of claim 10, wherein:
information about the three-dimensional point includes at least one of position information, size information, occupancy information, or color information by direction on a three-dimensional space of the three-dimensional point.

12. The method of claim 11, wherein:
the position information includes information identifying a layer in which the three-dimensional point is included and offset information showing an interval between layers under a multi-layer structure.

13. The method of claim 11, wherein:
size information of the three-dimensional point is determined as the radius of a spherical-shaped point.

14. The method of claim 11, wherein:
the occupancy information shows a transmittance for the three-dimensional point.

15. The method of claim 11, wherein:
the color information by direction includes coefficient information of a spherical harmonic function.

16. The method of claim 10, wherein:
the patch information further includes a flag indicating whether the patch includes a non-Lambert region.

17. The method of claim 16, wherein:
when a pixel to be reproduced in the viewport image is included in the non-Lambert region, a value of the pixel is obtained based on transparency information or color information by direction of the three-dimensional point.

18. The method of claim 10, wherein:
the patch information further includes a flag indicating whether there are three-dimensional points that are redundantly projected on a same position.

19. A computer readable recording medium recording an image encoding method, the computer readable recording medium comprising:
generating an atlas from at least one two-dimensional or three-dimensional image; and
encoding the atlas and metadata for the atlas,
wherein the metadata includes information about a patch packed in the atlas,
the patch information includes information about a three-dimensional point projected on a two-dimensional patch.
